(19) United States
(12) Patent Application Publication
(10) Pub. No.: US 2026/0257866 A1
(43) Pub. Date: Sep. 3, 2026

(54) DEVICE AND TRANSPORT POCKET FOR ROTATING, OPENING, FILLING AND UNLOADING TRANSPORT ELEMENTS WHICH ARE CONVEYED IN A SUSPENDED MANNER, FOR CONVEYING SYSTEMS

(71) Applicant: Ferag AG, Hinwil (CH)

(72) Inventors: Roberto Fenile, Hinwil (CH); Simon Beutler, Hinwil (CH)

(21) Appl. No.: 19/551,731

(22) Filed: Feb. 27, 2026

(30) Foreign Application Priority Data
Feb. 28, 2025 (CH) 000197/2025

(51) Int. Cl. B65G 17/48; B61B 3/00; B61C 11/02; B65G 17/20

(52) U.S. Cl. CPC B65G 17/485; B61B 3/00; B61C 11/02; B65G 17/20

(57) ABSTRACT

A conveying unit for the suspended transport of conveyed items in transport elements in a conveying system, in particular in a rail-led conveying system (50) or in a conveying chain system, includes a carrier hook which is attached to a conveying element, in particular to a runner vehicle or a conveying chain link, and also includes a transport element in the form of a transport pocket, and a suspension hook which is attached to the transport element. The suspension hook is mounted in the carrier hook in a suspended manner. The carrier hook is designed in a manner such that the suspension hook can assume at least three stable positions in the carrier hook. The suspension hook can be rotated with respect to the carrier hook about different angles so that the suspension hook can assume three different stable positions in the carrier hook.

The present invention relates to the field of transport and conveying technology. It concerns a conveying unit for the suspended transport of conveyed items by way of transport elements, in particular transport pockets, in a conveying system, in particular in a rail-led conveying system or in a conveying chain system. It further relates to a conveying system with such conveying units, to a method for bringing individual items into transport elements of a conveying system or for loading conveying units with conveyed items, as well as to a method for unloading individual items from transport elements of a conveying system or for unloading conveyed items from conveying units. Furthermore, the invention also relates to a rotation device for rotating the transport elements of conveying units.

### TECHNOLOGICAL BACKGROUND

In automated warehouses, vast production facilities and very generally concerning the conveying and transport of goods, suspended conveying systems have been proven to be an efficient means for the transport, the intermediate buffering, but also for the long-term storage of different types of goods. Regarding suspended conveying systems, in a suitable manner the goods are either suspended directly on individual conveying elements of a conveying system, for example coat hangers with pieces of clothing which are suspended thereon, or are brought into suitable transport elements such as for example transport pockets, which in turn are mounted on the conveying elements in a suspended manner.

Suspended conveying systems can be realised as transport chain facilities, concerning which a multitude of conveying elements form links of a chain which is moved along a conveying path.

Gravity-assisted conveying systems concerning which individual conveying elements which are provided with wheels move on corresponding runner rails are likewise known. One example of such a gravity-assisted, rail-led conveying system is known from WO 2016/030275 A1 of the applicant.

Suspended conveying systems with transport elements are particularly suited for the efficient conveying of heterogenic individual item goods such as for example workpieces in production processes, spare parts, consumer goods such as books, pieces of clothing, shoes, etc.

Hence for example suspended conveying systems are used in logistics centres of mail order companies, in order to store a multitude of articles of a different size and weight, and to order pick groups of articles according to the respective customer orders and to prepare them for shipping.

Herein, an aspect which is relevant to a suspended conveying system is the simple, smooth-running and efficient bringing of goods into empty transport elements and the unloading of the goods from the transport elements.

A manual filling of provided empty transport elements such as for example transport pockets permits a flexible, gentle handling of different goods, but is slow and cost-intensive.

It is thus known from the state of the art to apply suspended conveying devices with transport pockets for the transport of goods or articles, hereinafter called conveyed items for simplicity.

The publication documents DE 10 2004 018569 A1 and US 1146847 B2 for example describe a suspended conveying device with a plurality of conveying or collection pockets which can be folded together, for receiving and for the sorting collecting of objects, in particular pieces of clothing. The collecting pocket comprises a frame mount and a pocket pouch which is suspended on the frame mount. The collection pocket is suspended on the suspended conveying device or on a runner vehicle via a hook connection element which is attached to the frame mount.

The advantage of conveying pockets lies in the fact that these are designed in a foldable manner. By way of this, the receiving pocket can be compressed by way of folding together. In this manner, the conveying pockets permit space-saving logistics, which is in contrast for example to rigid boxes and containers. Empty conveying pockets with a compressed receiving compartment can thus be stored or conveyed in a space-saving manner. The receiving compartments do not need to be expanded to the extent that they take up space, until the transport or storage of the goods.

EP 2418160 B1 shows another loading station for transport pockets which are transported in a suspended conveying facility. The transport pockets comprise a frame bow which is suspended on a conveying element and on which two ends of a flexible material web are fastened and form a pouch. A pressure plate is arranged below the suspension hook of the pouch. A skid is arranged in the loading station, said skid on movement of transport pocket through the loading station pressing the pressure plate and thus also the transport pocket from an orientation transverse to the conveying direction into an orientation parallel to the conveying direction and holding it in this orientation over the course of the skid. The shape of the suspension hook is selected such that herein this is pressed upwards in the carrier hook of the conveying element away from a minimum of the potential energy. At the same time, the frame bow is also pressed outwards perpendicularly to the conveying direction and assumes a position in which the pouch is open to the top. In this position, the transport pocket can be filled from the side through the upper opening. After leaving the region of the skid, the suspension hook slides on the carrier hook back again to the minimum of potential energy and the pocket pivots back into an orientation transverse to the conveying direction.

The publication document CH 720950 A1 describes a conveying pocket for a suspended conveying facility for the suspended conveying of a conveyed item along a conveying track, wherein the conveying pocket considered in the conveying direction comprises a front pocket wall and a rear pocket wall which trails the front pocket wall, said pocket walls being connected to one another by a pocket base, and the front and rear pocket wall together with the pocket base delimit a main receiving compartment which is open to the top through a pocket opening. The conveying pocket further comprises a holding device for the clamping receiving of an extensive conveyed item on the outer side of at least one of the pocket walls, in particular the rear wall.

DE 10 2004 018569 B4 shows a further device for loading transport pockets in a suspended conveying facility. The transport pockets comprise a frame bow which is suspended on a conveying element transversely to the conveying direction and which defines an upper opening of the pocket. A flexible material web which is fastened to the frame bow at two ends forms a pouch for receiving individual item elements. Side walls only close a lower part of the sides of the pouch, so that lateral insert openings remain. On moving the transport pockets along the conveying path through the device, suitably designed slotted guides move the frame bow which is suspended in a perpendicular manner in the empty state of the transport pocket into an horizontal position in which the lateral insert openings are maximally opened. The articles can now be inserted into the pocket through the lateral openings. An automatic filling is not possible since the upper openings of the pockets are not accessible due to the runner rail of the conveying system.

WO 2018 142242 A1 shows a conveying unit for the suspended transport of transport elements in a conveying system, in particular in a rail-led conveying system or in a conveying chain system. The conveying unit comprises a carrier hook which is attached to a conveying element, in particular to a runner vehicle or a conveying chain link, and further comprises a transport element and a suspension hook which is attached to the transport element, wherein the suspension hook is mounted in the carrier hook in a suspended manner. The carrier hook is designed in a manner such that the suspension hook can assume two stable positions in the carrier hook. The suspension hook in a first stable position is rotated by an angle with respect to the suspension hook in a second stable position. The conveying system is designed with active arrangements for the active rotation of the transport pocket.

Modern transport elements such as for example transport pockets in suspended conveying facilities comprise several receiving spaces for conveyed items. The several receiving spaces can be designed differently, according to which conveyed item is to be conveyed. Given the lateral filling of the transport pockets with conveyed items, there arises the problem that the transport pockets are to be brought to the loading position into the correct alignment, in order to be able to efficiently carry out the filling. The transport pockets should be led onto the loading position in a correctly aligned manner, even for a manual filling of the transport pockets, thus by hand.

Transport pockets can hence be equipped with several receiving compartments which can be located on different side walls of the transport pockets. For filling the individual receiving compartments with conveyed items, it is then necessary for the transport pocket to be brought into the correct alignment before reaching the loading position, so that the conveyed item can be inserted into the envisaged receiving compartment. If the transport pocket is conveyed to the loading position in an incorrect alignment, it is necessary to manually rotate the transport pocket into the correct position, and such delays the loading or can lead to errors on loading the transport pockets.

There is generally the need for improvements in this field of technology.

### DESCRIPTION OF THE INVENTION

It is the object of the invention to provide a conveying unit for the suspended transport of transport elements in a conveying system, in particular in a rail-led conveying system or in a conveying chain system, which permits a simple and efficient charging or filling of the transport elements.

Another object of the invention is to provide a corresponding conveying system.

Yet a further object of the invention is the provision of a loading device or loading station which is to say an associated method for bringing conveyed items into transport elements of the conveying units.

The conveying unit in particular is to permit the charging or the filling of the transport elements with conveyed items from a first side and a second side which in particular lies opposite the first side—considered in the conveying direction.

A further object of the invention is the provision of an unloading device or unloading station which is to say an associated method for unloading conveyed items from transport elements of the conveying units.

In particular, the conveying unit is to permit the unloading of the transport element with conveyed items to a first side and to a second side which in particular lies opposite the first side considered in the conveying direction.

A further object of the invention is the provision of transport pockets for conveying units of a corresponding conveying system.

These and other objects are achieved by a conveying unit according to the invention, a conveying system according to the invention and a rotation device according to the invention, as well as a loading and unloading method according to the invention and a transport pocket, according to the independent claims. Further embodiments and further developments are specified in the dependent claims.

It is therefore also an object of the present invention to suggest a rotation device for transport elements, such as transport pockets, for suspended conveying facilities, said rotation device rotating and aligning a transport element, e.g. a transport pocket with several receiving compartments, to the envisaged side before reaching the loading positions, so that this transport element can be loaded and possibly previously opened.

The conveying unit according to the invention for the suspended transport of transport elements in a conveying system, in particular in a rail-led conveying system or in a conveying chain system comprises:
a carrier hook which is attached to a conveying element, in particular to a runner vehicle or to a conveying chain link,
a transport element, and
a suspension hook which is attached to the transport element, wherein the suspension hook is mounted in the carrier hook in a suspended manner

According to the invention, the carrier hook is designed in a manner such that the suspension hook can assume at least three stable positions in the carrier hook. Hereby, the suspension hook in a first stable position is rotated about an angle with respect to the suspension hook in a second stable position, i.e. in relation to the second stable position of the suspension hook. Furthermore, the suspension hook in the first stable position is rotated with respect to the suspension hook in a third stable position, i.e. in relation to the third stable position of the suspension hook, about an angle which is different than that in the second stable position.

In the first stable position, the transport element is situated in particular in a conveying position. In the second stable position, the transport element in particular is situated in a loading or unloading position. In the third stable position, the transport element in particular is situated in a loading or unloading position.

“Stable position” in particular means that the suspension hook or the conveying element with the suspension hook remains in its position or rotation position on the carrier hook in an idle position. “Idle position” in particular means that the associated conveying unit is not situated in a conveying movement. This can be the case e.g. at a loading or unloading station.

The suspension hook remaining in the “stable position” can be effected without outside intervention. In particular, this is the case at the first stable position.

The suspension hook remaining in the “stable position” can also be effected by a stop element which from the outside acts upon the suspension hook or the transport element in the stable position. The stop element e.g. in a stop position in which the transport element or the suspension hook hits or abuts upon the stop element, prevents a pivoting of the transport element from the second or third stable position back into the first stable position.

The carrier hook can be an open or closed hook. A closed hook can also be present e.g. as an eyelet which is to say an annular or loop-like body.

A further advantageous development of the conveying unit is effected by way of the suspension hook being able to be brought or moved to and fro between the first stable position and the second stable position and the third stable position in a manner such that the suspension hook lies constantly on the carrier hook.

This means that the suspension hook can be brought to and fro between the first stable position and the second stable position as well as between the first stable position and the third stable position in a manner such that the suspension hook lies constantly on the carrier hook.

According to a further advantageous development of the conveying unit, the carrier hook comprises a first rest position or location, a second rest position or location and a third rest position or location, for the suspension hook. The suspension hook in the first stable position lies on the first rest position or location, in the second stable position on the second rest position or location, and in the third stable position on the third rest position or location.

A connection segment is arranged in each case between the first rest position and the second rest position and the third rest position, on which connection segment the suspension hook can be brought to and fro between the first stable position, the second stable position and the third stable position in a sliding manner.

Thus, in particular a first connection element is arranged between the first rest position or location and the second rest position or location and a second connection element between the first rest position or location and the third rest position or location.

In particular, the connection segments are designed as arm sections of the carrier hook.

The first, second and third rest position or location in particular have spatial arrangements on the carrier hook which are different to one another.

The first rest position or location in a projection of the rest positions or locations onto a plane perpendicular to the conveying direction, in particular is arranged between the second and third rest position or location.

The first rest position or location in particular is arranged in a manner leading, i.e. preceding the second and third rest position or location in the conveying direction.

The first, second and third rest position or location in particular are formed by rest surfaces.

The first rest position or location can be formed by a recess, groove or trough on the carrier hook. The axis of the recess or trough in particular runs parallel to the conveying direction. The first rest position or location in a horizontal position of the conveying element can also be formed by a horizontally aligned rest surface.

The second rest position or location can be formed by a recess or trough on the carrier hook. The axis of the recess or the trough in particular runs transversely or perpendicularly to the conveying direction. The second rest position or location in a horizontal position of the conveying element can also be formed by a horizontally aligned rest surface.

The third rest position or location can be formed by a recess or trough on the carrier hook. The axis of the recess or trough in particular runs transversely or perpendicularly to the conveying direction and possibly also parallel to the axis of the recess or trough of the second rest position or location. The third rest position or location in a horizontal position of the conveying element can also be formed by a horizontally aligned rest surface.

The width of the recess or the trough can correspond to the diameter of the suspension hook in the contact section to the carrier hook.

According to a further, advantageous development of the conveying unit, the carrier hook is designed in a manner such that the suspension hook in a certain first spatial orientation on the first rest position or location can assume the first stable position in which the suspension hook is aligned in a first plane. Furthermore, the suspension hook in a second spatial orientation on the second rest position or rest location which is different from the certain first spatial orientation can assume the second stable position in which the suspension hook is aligned in a second plane. Furthermore, the suspension hook in a third spatial orientation in the third rest position or location which is different from the certain second spatial orientation can assume the third stable position in which the suspension hook is aligned in a third or likewise in the second plane.

In other words, the carrier hook is designed in such a manner that in a certain first spatial arrangement of the first rest position or location on the carrier hook, the suspension hook on the first rest position or location can assume the first stable position in which the suspension hook is aligned in the first plane. Furthermore in a second spatial arrangement of the second rest position or location on the carrier hook which is different from the certain first spatial arrangement, the suspension hook on the second rest position or location can assume the second stable position in which the suspension hook is aligned in a second plane. Moreover, in a third spatial arrangement of the third rest position or location on the carrier hook which is different from the certain second spatial arrangement, the suspension hook on the third rest position or location position can assume the third stable position in which the suspension hook is aligned in a third or likewise in the second plane.

In a certain first spatial orientation or arrangement of the first rest position or location of the carrier hook, the first stable position in particular corresponds to a minimum of the gravitational potential energy of the transport element which is mounted in a suspended manner.

The suspension hook in the first stable position in particular has a lower or the lowest gravitational potential energy compared to the second and third stable position.

Thus, the first rest position or location and herewith also the suspension hook in the first stable position in particular lies at a lower level along a horizontal conveying path considered in the direction of gravity, in comparison to the second and third rest position or location or the second and third stable position.

In particular, this is the case when the carrier hook is situated in a conveying position.

By way of rotating the suspension hook about a certain rotation angle, e.g. by 90° (angle degrees) this can be brought or moved to and fro between the first position and the second position or the third position on the carrier hook.

The rotation angle in each case is e.g. 45° to 150°, in particular 90° (angle degrees).

In particular, the rotation axis runs perpendicularly to the conveying direction. The rotation axis in particular runs through a longitudinal axis of the transport element, in particular through a middle longitudinal axis of the transport element. The longitudinal axis or middle longitudinal axis of the freely suspended transport element in particular is aligned in a vertical manner.

The conveying unit according to the invention comprises a transport element with a suspension hook, wherein the suspension hook in particular by way of rotating the transport element about a vertical of the conveying direction can be brought or moved to and fro between the first stable position and the second stable position and the third stable position

The suspension hook can be an open or closed hook. A closed hook can comprise for example an eyelet which is to say an annular or loop-shaped body.

An upper section of the suspension hook which is hung into the carrier hook and which is e.g. an arch piece in particular lies in a (first) plane.

The plane of the upper section in the first stable position in particular is aligned parallel to the conveying direction. The plane of the upper section in the second and/or third stable position in particular is aligned perpendicularly to the conveying direction.

The suspension hook can comprise a lower section which faces a receiving compartment of the transport element and which is connected e.g. to a carrier frame or a transverse rod of the transport element. The lower section in particular lies in a second plane. This second plane in the conveying position of the transport element in particular is aligned perpendicularly to the conveying direction.

The first plane of the upper section and the second plane of the lower section in particular run parallel to a middle longitudinal axis of the transport element. In particular, the two planes are arranged at an angle to one another.

The upper section of the suspension hook is rotated or twisted in particular about an angle and very particularly about 90° with respect to the lower section. In particular, the rotation is a rotation about the longitudinal axis or middle longitudinal axis of the transport element and very particularly a rotation about the vertical with respect to a suspended position of the transport element. In particular, the rotation or twist is permanent.

The transport element of the conveying unit in particular is a container with at least one flexible wall, in particular a flexible fabric wall.

The transport element in particular forms a receiving compartment for a conveyed item.

The transport element of the conveying unit in particular forms a carrier frame. The carrier frame can comprise an upper transverse rod. The transverse rod in the conveying position is aligned in particular transversely to the conveying direction.

The transport element in particular forms a rear wall and front wall.

According to a further development, the conveying unit comprises a transport element, wherein the transport element is a container with at least one stable wall, in particular a wall of a hollow-chamber plate.

The transport element of the conveying unit serves for the receiving of conveyed items.

In particular, the transport element is a transport pocket.

The transport pocket in particular forms a rear pocket wall, also called rear wall, and a front pocket wall, also called front wall, said walls being flexibly connected to one another via a pocket base in such a manner that they can move between a first state in which they form a receiving compartment which is open to the top and can be filled from above, and a second state in which they lie tightly next to one another and form a folded-together pocket. These states can be achieved by way of them being movable to and fro.

In particular, the rear wall is extended upwards beyond the height of the front wall with a carrier section for fastening the transport pocket to the conveying element.

In particular, the suspension hook is attached to an upper end of the carrier frame of the transport element which is to say connected to the carrier frame.

In particular, the suspension hook is connected to the carrier frame via an upper transverse rod of the carrier frame.

The conveying unit according to the invention with a transport pocket forms a main receiving compartment for conveyed items. According to a further development the transport pocket comprises at least one further auxiliary receiving compartment on at least one pocket wall of the transport pocket.

The invention also relates to a rotation device for rotating the transport elements of conveying units in a conveying system, in particular in a conveying system which is guided by conveying rails or in a conveying chain system, for the suspended conveying of conveyed items along a conveying corridor.

In particular, what is mean by a “conveying corridor” is a conveying space which leads along a conveying direction and through which the conveying units or the conveying elements of the conveying units move.

The conveying system in particular comprises at least one loading station to which the transport elements can be conveyed. The transport elements are rotatable about their vertical axis for loading at the loading station.

The rotation device is characterised in that this comprises at least one activatable active element which can be brought from an idle position into the conveying corridor of the transport elements into an active position such that the transport elements in the conveying direction rotate to the right or to the left about their vertical axis, before the pocket reaches e.g. its loading position in the loading station.

The activatable active element can also be called actuating element or actuator element.

The at least one active element is arranged in particular outside the conveying corridor in its idle position.

The rotation procedure is activated by way of the transport elements during their conveying hitting an active element which projects or engages into the conveying corridor. In particular, the transport elements hit the active element with an out-of centre section.

The transport elements are rotated to the right or left, in particular by 90° by way of the rotation device which is to say the active element.

In particular, the at least one active element is moved from above into the conveying corridor into its active position. The at least one active element however can also be moved into the conveying corridor into its active position from the side or from below.

In particular, the rotation device comprises a drive unit which drives the at least one active element.

The rotation device according to the invention in particular comprises two active elements which can be activated at alternate sides and which in an idle position are arranged outside the conveying corridor. “Activated at alternate sides” in particular means “interchangeably activatable”

Hence a first active element ensures that the transport element is rotated to the right and a second active element that the transport element is rotated to the left.

Thus, considered in the conveying direction, the first active element can be arranged to the right and the second active element to the left of the carrier hook of the conveying unit which is led past, or of a conveying rail or a conveying chain of the suspended conveying device.

The two active elements can be mechanically coupled to one another and be moved into the conveying corridor and back out of this again from above or below at alternate sides via a rotation axis. The active elements can thus be mechanically coupled to one another as a rocker via a rocker design.

The rotation device according to the invention in particular is driven by a drive unit which switches the two active elements at alternate sides.

In particular, the drive unit for driving the at least one active element is controlled by a control device.

The at least one active element of the rotation device according to a preferred further development is designed in a rod-like manner.

A further development of the rotation device comprises active elements which are designed as rollers.

The rotation device according to the invention comprises at least one active element which in the region of the carrier frame of the transport elements can be brought into the conveying corridor of the transport elements. Given two active elements these can be brought into the conveying corridor of the transport elements in the region of the carrier frame of the transport elements at alternate sides.

According to an embodiment variant of the conveying system, the carrier hook can be inclined or tilted along the conveying track in a plane which is arranged perpendicularly to the conveying direction, so that given an inclination of the carrier hook in a first inclination direction, the suspension hook on the second rest position or location can assume the second stable position and given an inclination of the carrier hook in a second inclination direction which is opposite to the first inclination direction, the suspension hook on the third rest position or location can assume the third stable position. The inclination positions of the carrier hook in particular relate to loading or unloading positions.

In an inclination-free position of the carrier hook, the suspension hook on the first rest position can assume the first stable position. The inclination-free position in particular corresponds to the conveying position of the carrier hook or of the conveying unit.

A “stable position” here in particular means that the suspension hook cannot slip or slide out of the rest position or location on its own accord. On account of the inclining or tilting of the carrier hook, the first rest position or location—depending on the inclination direction—is lifted to a higher level of potential energy compared to the second or compared to the third rest position or location.

According to a further development, given an inclination of the carrier hook in the first inclination direction, the second rest position or location has the lowest potential energy level compared to the first and third rest position or location. By way of this, on account of gravity and in particular in an automatic manner the suspension hook slips from the first into the second rest position or location. Furthermore, given an inclination of the carrier hook in the second inclination direction, the third rest position or location has the lowest potential energy level compared to the first and second rest position or location. By way of this, on account of gravity and in particular in an automatic manner the suspension hook slips from the first into the third rest position or location. Furthermore, given an inclination-free position of the carrier hook, the first rest position or location has the lowest potential energy level compared to the second and third rest position or location. By way of this, on account of gravity and in particular in an automatic manner the suspension hook slips from the second or third back into the first rest position or location.

The inclination of the carrier hook is achieved for example by way of a corresponding inclination of the runner vehicle. Whereas in the conveying position a runner vehicle plane which is arranged perpendicularly to the rotation axes of the carrier rollers of the runner vehicle is aligned vertically, this runner vehicle plane forms an acute angle to a vertical in the inclined or tilted position of the runner vehicle.

The runner vehicle and with this the carrier hook in turn can be inclined in the first or second direction by way of a twisting or torsioning of the runner rail along the conveying track. Therefore at loading or unloading stations in which the runner vehicle or carrier hook as well as the transport element assumes a loading or unloading position, the runner rail can thus have a twisting compared to a conveying section in which the runner vehicle or carrier hook as well as the transport element assumes a conveying position.

Thanks to this further development, a rotation device can possibly be done away with. However, one can also envisage the assistance by a rotation device becoming necessary for bringing in each case into another stable position.

In particular, the transport elements are conveyed with a rear wall which is orientated transversely to the conveying direction. The suspension hook is herein located in the first rest position or location in a first stable position.

The invention also relates to a loading device or station and to an associated method for loading transport elements with conveyed items. The loading with the conveyed items is effected transversely to the conveying corridor of the transport elements.

This means that the transport elements are loaded from the side considered in the conveying direction and in particular transversely to the conveying direction.

Before the loading, the transport elements in or in front of the loading station are rotated about their vertical axis into the alignment which is envisaged for loading, by way of the rotation device.

According to a further development of the loading device or station or of the associated method, the transport elements are pivoted about the carrier hook transversely to the conveying direction, in particular about 45° to 150°, very particularly 90°, for loading with conveyed items.

The transport elements can thus be rotated about a rotation angle of 90° from a conveying alignment in which the rear wall is arranged transversely to the conveying direction, towards one of the two sides into a loading alignment in which the rear wall is arranged parallel to the conveying direction.

Depending on the rotation towards the first or second side, the suspension hook is herein located at the second or third rest location in the second or third stable position.

Herein, in particular in a selective manner, the transport elements can be rotated towards both sides by way of the rotation device and be brought into the second or third stable position.

The invention also relates to an unloading device or station as well as to a method for unloading transport elements of conveyed items. The unloading of the conveyed items is effected transversely to the conveying corridor of the transport elements.

This means that the transport elements considered in the conveying direction are unloaded from the side and in particular transversely to the conveying direction.

Before the unloading in or in front of the unloading device or station, the transport elements are rotatable about their vertical axis into the envisaged alignment for unloading by way of a rotation device.

According to a further development of the unloading device or station or of the method for unloading transport elements of conveyed items, the transport elements are pivoted about the carrier hook transversely to the conveying direction for unloading the conveyed item, in particular about 45° to 150°, very particularly about 90°.

The transport elements can thus be rotated about a rotation angle of 90° from a conveying alignment in which the rear wall is arranged transversely to the conveying direction, towards one of the two sides into an unloading alignment in which the rear wall is arranged parallel to the conveying direction.

Depending on the rotation towards the first or second side, the suspension hook is herein situated on the second or third rest location in the second or third stable position.

The transport elements can herein be rotated selectively towards both sides by way of the rotation device and be brought into the second or third stable position.

The invention also relates to a conveying system for the guided, suspended transport of transport elements, in particular transport pockets, along a conveying track.

The conveying system can be a rail-led conveying system with a conveying rail and with at least one conveying unit which is described further above, along which conveying rail conveyed items are conveyed or transported in a suspended manner by way of the conveying units or their transport elements.

The conveying system can be a conveying chain system with a conveying chain and with at least one conveying unit which is described further above, along which conveying chain conveyed items are conveyed or transported in a suspended manner by way of the conveying units or their transport elements.

The conveying system in particular comprises at least one loading device or station.

The conveying system in particular comprises at least one unloading device or station.

The conveying system in particular comprises at least one rotation device. Thus, for example a rotation device is arranged upstream of the at least one loading device or station. Furthermore, in particular a rotation device is also arranged upstream of the at least one unloading device or station.

The conveying system can also comprise at least one stop and release device which is arranged upstream of the at least one loading station as well as in particular also upstream of a rotation device which is assigned to the loading station.

The conveying system can also comprise at least one stop and release device which is arranged upstream of the at least one unloading station as well as in particular also upstream of a rotation device which is possibly assigned to the unloading station.

The stop and release device serves for stopping the conveying units along the conveying path and the release of the conveying units for the individual or grouped further transport e.g. towards the loading or unloading device.

The invention also relates to a transport pocket for conveying units of a conveying system, in particular of a conveying system which is guided by conveying rails or of a conveying chain system, for the suspended conveying of conveyed items along a conveying rail.

This means that the transport elements of the conveying units in particular are transport pockets.

The transport pocket in particular comprises a carrier frame and in the upper part of the carrier frame comprises a suspension hook. The suspension hook forms in particular an upper section, e.g. in the form of an eyelet.

The carrier frame can encompass e.g. a pocket opening. The carrier frame can frame e.g. a rear wall.

The carrier frame of the closed transport pocket in the conveying position is aligned in particular perpendicularly to the conveying direction.

The upper section or the eyelet of the suspension hook in particular is rotated at right angles with respect to the carrier frame of the closed transport pocket.

The rotation device according to the invention in particular can also interact with an unloading device. Thus, it is possible for the transport pocket with the conveyed item to be firstly rotated by the rotation device and the transport pocket to be able to be subsequently emptied. This e.g. is effected by way of the transport pocket being lifted at the outermost end until the conveying item falls out of the transport pocket.

Generally, an unloading device can also be operated without a rotation device. It is therefore possible for the transport pocket with the conveyed item to remain aligned transversely to the conveying direction. On account of the design of the transport pocket according to the invention with the suspension hook which comprises an eyelet which is rotated by 90° (angle degrees) for hanging into the carrier hook, the transport pocket can then be emptied by way of the transport pocket being lifted at the outermost end until the conveyed item falls out of the transport pocket.

Advantageously, at least one active element of the rotation device is arranged on both sides of the conveying rail or conveying chain. By way of this, the one active element can act to the right of the conveying rail or conveying chain and the other to the left of the conveying rail or conveying chain.

In particular, the control device controls the complete course of the devices or of the conveying system. It can be additionally designed to control the flow of goods within the conveying facility or the conveying system.

The control device controls the stop and release device in order on the one hand to be able to stop the conveying units but also on the other hand to be able to release the conveying units for the conveying.

The suspension hook at the uppermost end forms an eyelet which lies on the carrier hook. In particular, the eyelet is rotated by 90° (angle degrees) to the carrier frame of the transport pocket. In the conveying state of the transport pocket, the eyelet is aligned parallel to the conveying direction of the transport pocket.

The invention is described for a conveying facility or conveying system with an outer runner as a runner vehicle. Of course, the conveying facility according to the invention is also suitable for inner runners as a runner vehicle of the conveying facility or of the conveying system, wherewith this invention also includes an inner runner facility.

A conveying unit can comprise one or more receiving spaces for conveyed items. The receiving space or spaces in particular can be closed in a movable manner. A transport element can be a transport pocket which comprises several receiving spaces in the form of receiving compartments within the transport pocket or at the outside on the pocket walls of the transport pocket.

The receiving spaces can be closable and the conveyed item can be conveyed held in a carrying manner. However, the conveyed item can also be held in a clamping manner during the conveying. A clip can also be considered as a receiving space or as a receiving compartment since the conveyed item is held and conveyed in a clamping manner.

Other receiving compartments can also be filled with conveyed items during the conveying. The conveying unit can thus simultaneously convey several conveyed items.

A further variant of a conveying unit according to the invention can be a coat hanger which can be applied as a transport element. Hereby, it is often advantageous for the pieces of clothing to be able to be rotated with the coat hanger, for example for the purpose of inspection. Thus, pieces of clothing can be temporarily suspended on coat hangers for the further processing, for example for the processing of returns in mail order trade or for coat racks.

With the help of the rotation device, transport pockets can either be rotated to the left or to the right considered in the conveying direction. Hence different transport pocket sides can be filled with conveyed items at a loading device or station. Thus, different receiving compartments of a transport pocket can be loaded with conveyed items.

The carrier frame of transport pockets can be of one part or however be constructed in a multi-part manner.

The transport pocket can be fastened to the runner vehicle via a pocket wall. A receiving compartment can be attached to this pocket wall in a leading manner, or however also attached in a trailing manner. The pocket wall which is fastened to the runner vehicle can however also comprise a trailing receiving compartment and a leading receiving compartment. Furthermore, the transport pocket can be equipped with further receiving compartments for conveyed items.

Transport elements according to the invention however can also be transport mounts which convey conveying items. The transport mounts thus as a rule comprise placement locations at which the conveyed items can be suspended or put down. These transport mounts often need to be rotated and aligned for the loading or for unloading.

The subject-matter of the invention is hereafter explained in more detail by way of embodiment examples which are represented in the accompanying figures. In each case shown schematically are:

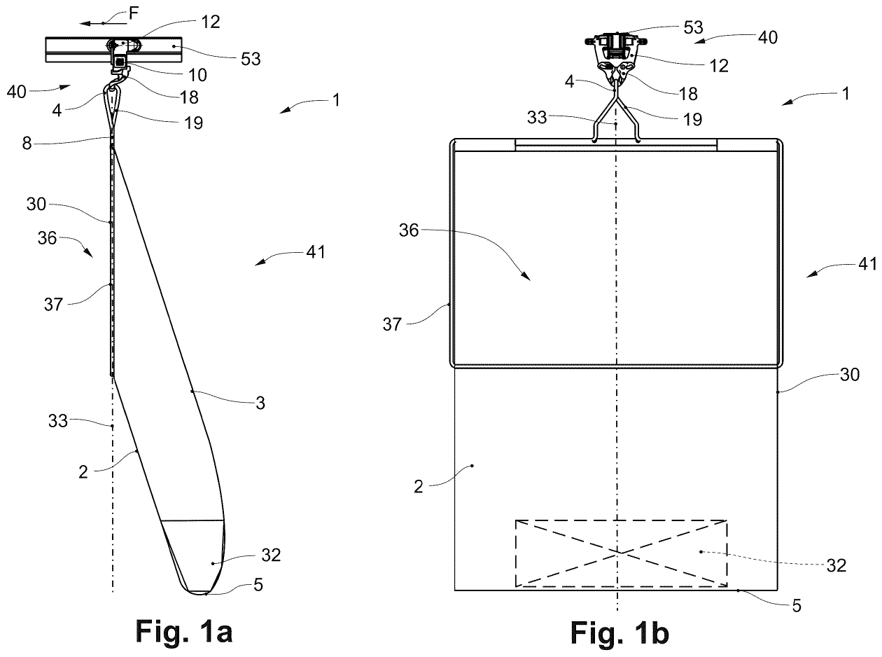

FIG. 1a: a conveying device according to the invention in a lateral view;

FIG. 1b: a front view of a conveying device according to the invention;

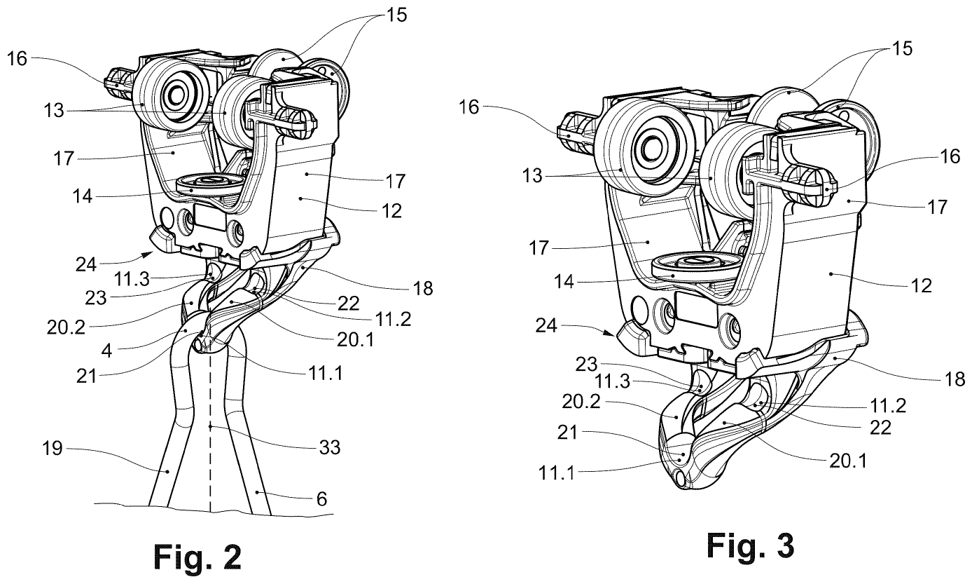

FIG. 2: a perspective view of a conveying device according to the invention, of runner vehicles with suspension;

FIG. 3: a perspective view of the conveying device according to the invention of runner vehicles with carrier hooks;

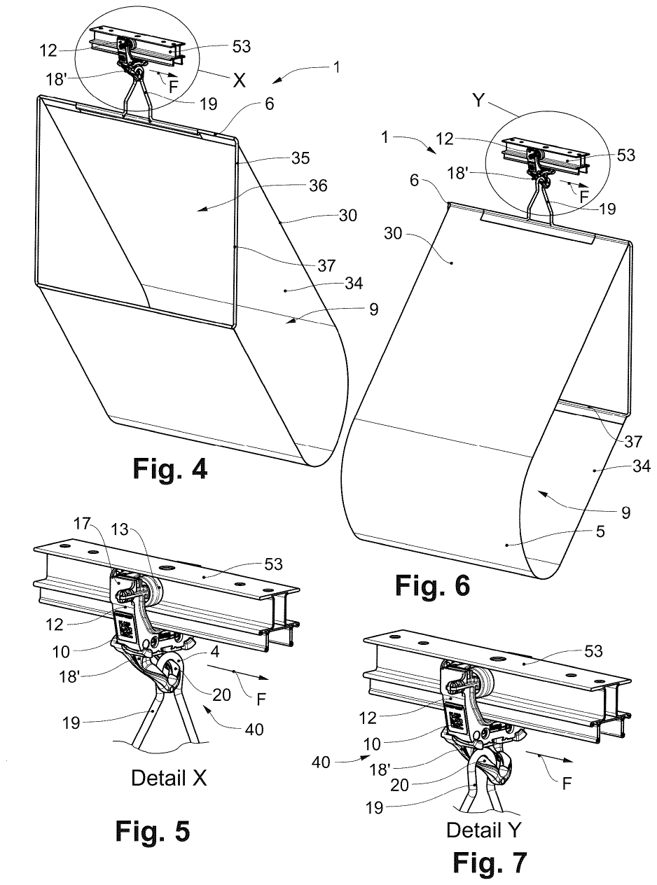

FIG. 4: a perspective view of the conveying device according to the invention, with the front side of an opened transport pocket;

FIG. 5 a perspective view of a detail of FIG. 4;

FIG. 6: a perspective view of a conveying device according to the invention, with the rear side of an opened transport pocket;

FIG. 7: a perspective view of a detail of FIG. 6;

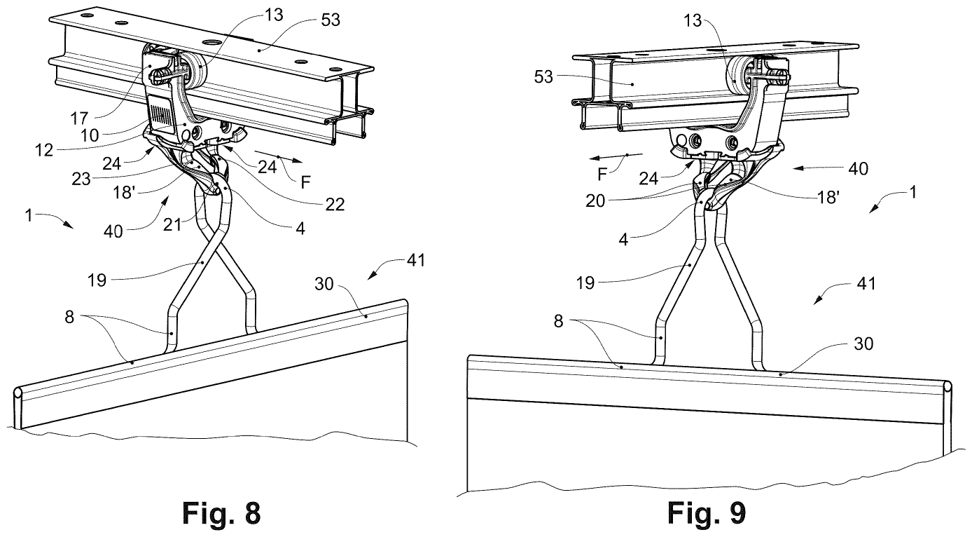

FIG. 8: a perspective view of the conveying device according to the invention in the conveying position, from the left;

FIG. 9: a perspective view of the conveying device according to the invention in the conveying position, from the right;

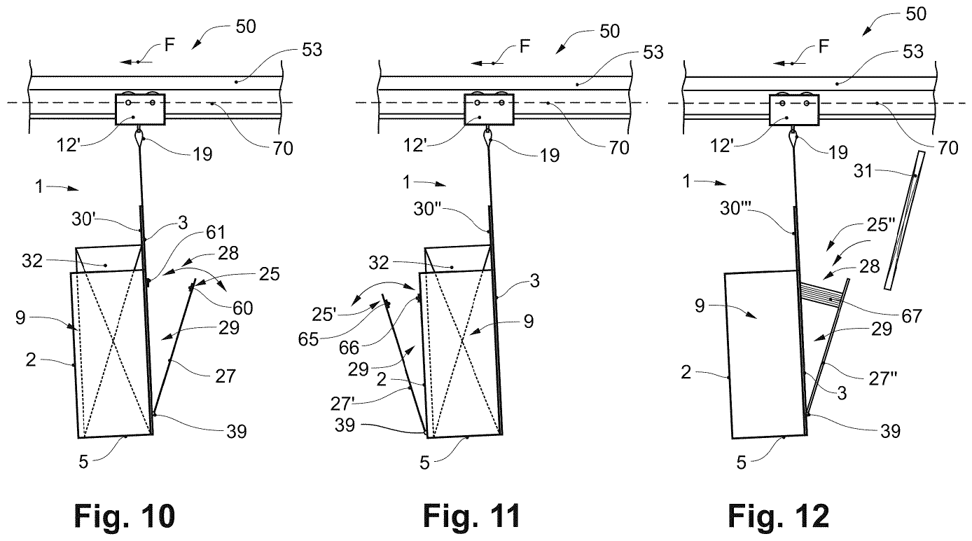

FIG. 10-12: different transport pockets with a main conveying compartment and an auxiliary conveying compartment, in each case in the conveying position;

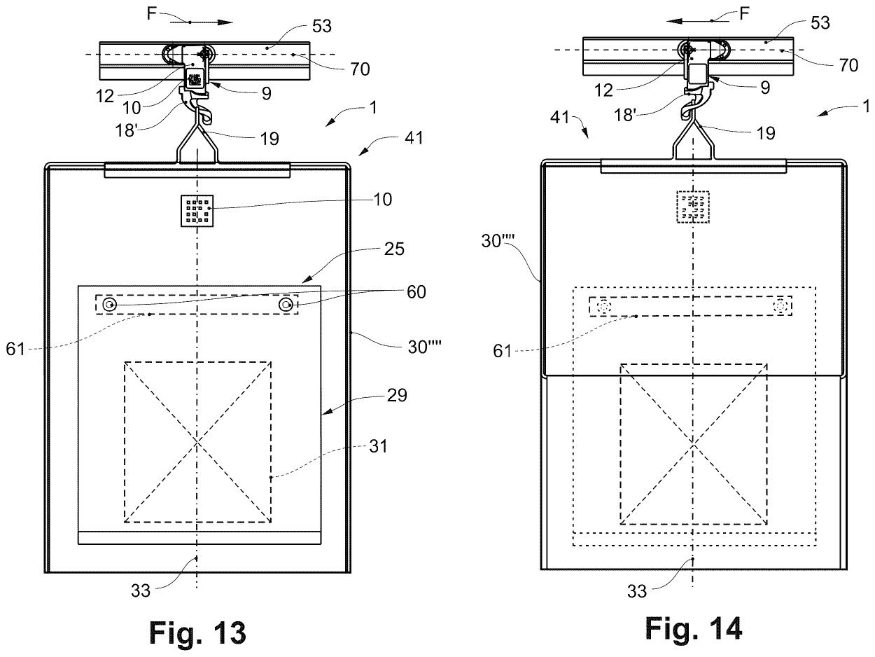

FIG. 13: a lateral view of the conveying device according to the invention with a transport pocket in the loading position with a parallel alignment of the transport pocket to the conveying direction;

FIG. 14: a lateral view of the conveying device according to the invention as in FIG. 13, but the rear side;

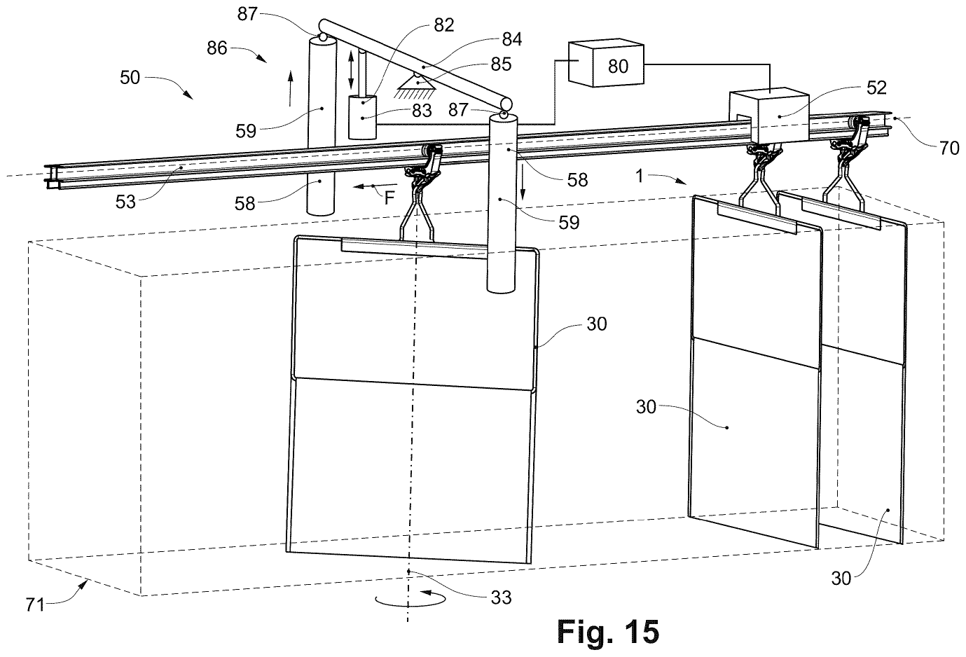

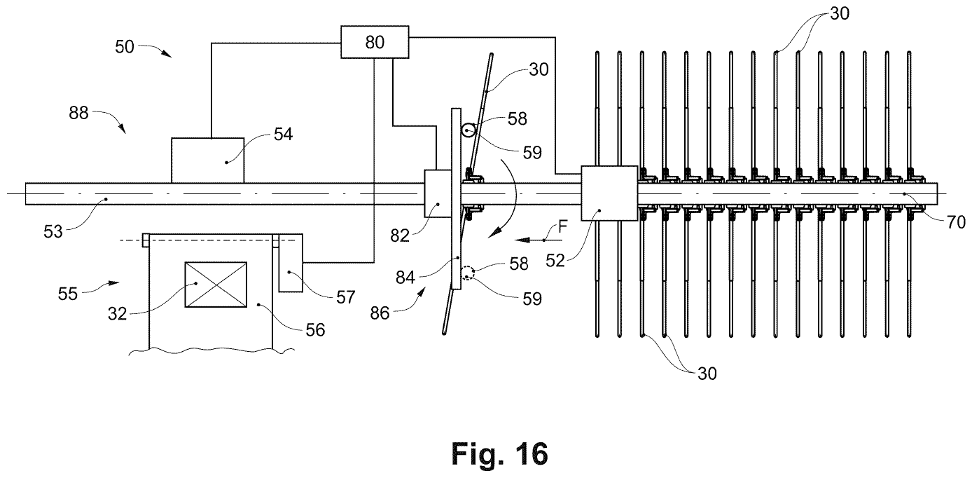

FIG. 15: a perspective view of the rotation device according to the invention;

FIG. 16: a perspective view of the loading station according to the invention.

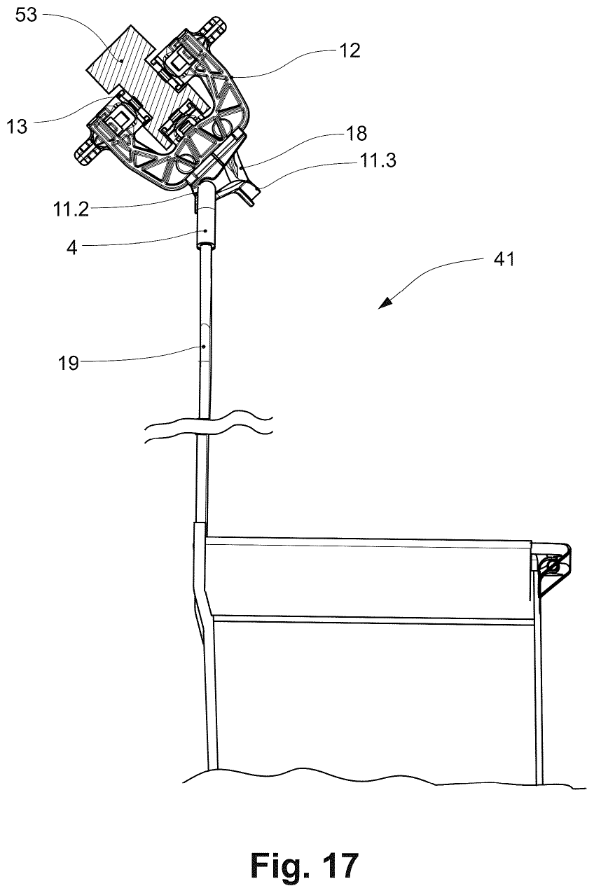

FIG. 17: a perspective view of a runner vehicle which is led in the conveying rail, with a carrier hook in a loading or unloading position, according to a further embodiment.

The embodiment examples which are described hereinafter are merely to be understood as exemplary of the subject-matter of the invention and have no limiting effect. Basically, in the figures the same parts are provided with the same reference numerals.

FIG. 1a shows a conveying unit 1 with a conveyed item 32 in a lateral view. The FIG. 1b shows the same conveying unit 1 from the front. The conveying unit 1 comprises a conveying element 40 in the form of a runner vehicle 12 and a transport element 41 in the form of a transport pocket 30. The transport pocket 30 comprises a carrier frame 8, to which a carrier loop, in particular a fabric loop is fastened. The upper end of the carrier loop is fastened to an upper transverse rod of the carrier frame 8. The other, lower end of the carrier loop is fastened to a lower transverse rod of the carrier frame 8 of the transport pocket 30.

The conveying element 40 comprises the runner vehicle 12 with a carrier hook 18 which is arranged or fastened thereto. The runner vehicle 12 comprises carrier rollers 13 and via these runs in the conveying direction F in or along a conveying rail 53 in a guided manner. At the upper end or at the upper transverse rod, the carrier frame 8 forms a loop-like eyelet 4 which is used as a suspension hook 19 of the transport pocket 30. The suspension hook 19 of the carrier frame 8 of the transport pocket 30 is hung into the carrier hook 18 of the runner vehicle 12.

The carrier frame 8 of the transport pocket 30 consists of a deformed wire which forms a closed frame, in the form of a wire frame 37. The upper end of the suspension hook 19, thus the eyelet 4 is rotated to the carrier frame 8 by 90°. The wire frame 37 forms the pocket opening 36 through which the transport pocket 30 is filled with conveyed items 32 such as for example articles. A rear pocket wall 3 which forms a side wall of the transport pocket 30 is located behind the pocket opening 36. A front pocket wall 2 is fastened to the lower transverse rod of the carrier frame 8 and forms the second side wall of the transport pocket 30. The two side walls are connected to one another to the bottom by way of the pocket base 5. The space which is delimited between the front pocket wall 2, the rear pocket wall 3 and the pocket base 5 is a receiving compartment and is used as a main receiving compartment 9 for conveyed items 32.

A transport pocket 30 can comprise further receiving compartments for conveyed items 32, in particular auxiliary conveying compartments.

The transport pocket 30 comprises a vertical 33 in the pocket middle, about which the transport pocket 30 can be rotated, which to say is pivoted. The vertical 33 accordingly forms a rotation axis.

The transport pocket 30 can be constructed in a symmetrical manner.

The runner vehicle 12 can be driven by way of a drive device which is not shown here.

FIG. 2 and FIG. 3 show the runner vehicle 12 with a carrier hook 18 in a perspective view. The runner vehicle 12 consists of a U-shaped main body which forms two runner vehicle limbs 17. A carrier roller 12 is arranged at the inner side on each of the two runner vehicle limbs 17. The carrier rollers 13 assume the carrying load of the conveyed item 32. Two support rollers 15 which are arranged flush with the carrier rollers 13 are arranged behind the two carrier rollers 13. The carrier rollers 13 and support rollers 15 run in the conveying rail 53, wherein the runner vehicle 12 is designed as an outer runner. Two guide rollers 14 are arranged one after the other below the carrier rollers 13 and the support rollers 15 in a manner such that their rotation axes are orientated orthogonally to the rotation axes of the carrier rollers 13 and support rollers 15. The guide rollers 14 serve for the lateral guidance of the runner vehicle 12. The runner vehicle 13 laterally on the runner vehicle limbs 17 comprises a driver bolt 16 which projects outwards on the runner vehicle limb 17. The runner vehicle 12 can be driven at the driver bolts 16 with the help of driver elements which are not shown here.

In FIGS. 2 and 3, a carrier hook 18 is fastened to the runner vehicle 12 below the runner vehicle 12. The fastening here is realised via a swallowtail guide which is secured via a snap connection 24. The connection between the runner vehicle 12 and the carrier hook 18 can be released again.

A suspension hook 19 is inserted or hung into the carrier hook 18 in FIG. 2. The loop-like eyelet 4 of the suspension hook 19 lies in the first stable position 21 of the carrier hook 18. The eyelet 4 is held in a first recess 11.1 which forms the first stable position 21. The first stable position 21 of the carrier hook 18 is characterised in that the transport pocket 30 or the upper transverse rod below the suspension hook 19 is aligned perpendicularly to the conveying direction F of the runner vehicle 12. A rotating or pivoting of the transport pocket 12 about the vertical 33 leads to the winding of the suspension hook 19 of the transport pocket 30 out of the first stable position 21 of the carrier hook 18.

The rotating or pivoting of the transport pocket 12 or a rotating of the frame mount 6 of the transport pocket 1 in the anti-clockwise direction leads to the eyelet 4 winding itself out of the first stable position 21 and pushing upwards to the left along a first connection segment 20.1 which is arranged between the first 21 and a second position 22, until the eyelet 4 of the suspension hook 19 reaches the second stable position 22 where the eyelet 4 is held at least temporarily in a first recess 11.1 which forms the second stable position 22. On account of the rotation of the frame mount 6 of the transport pocket 30, the alignment of the transport pocket 30 or of the upper transverse rod is now parallel to the conveying direction F of the runner vehicle 12. The pocket opening 36 is aligned to the left in the conveying direction F of the runner vehicle 12. The transport pocket 30 can now be filled for example laterally from the left.

A rotating of the frame mount 6 of the transport pocket 1 in the clockwise direction leads to the eyelet 4 winding itself out of the first stable position 21 and pushing upwards to the right along a second connection segment 20.2 which is arranged between the first 21 and a third position 23, until the eyelet 4 of the suspension hook 19 reaches the third stable position 23 where the eyelet 4 is held at least temporarily in a third recess 11.3 which forms the third stable position 22. On account of the rotation of the frame mount 6 of the transport pocket 30, the alignment of the transport pocket 30 or its upper transverse rod is now also parallel to the conveying direction F of the runner vehicle 12. The pocket opening 36 is aligned to the right in the conveying direction F of the runner vehicle 12. The transport pocket 30 can be filled for example laterally from the right.

The carrier hook 18 has three mentioned recesses 11.1-11.3 for the suspension hook 19, in which recesses the suspension hook 19 or its eyelet can assume a stable position or location. In each of the three stable positions or locations 21, 22, 23, the transport pocket 30 has a different alignment relative to the runner vehicle 12 and to the conveying direction F of the runner vehicle 12. On account of the different alignments of the transport pocket 30, different operations can be carried out with the transport pocket 30, such as filling, emptying or conveying the transport pockets 30.

FIG. 4 and FIG. 6 show the same runner vehicle 12 with a modified carrier hook 18′ and the same transport pocket 30 as in FIG. 1 and FIG. 2. However, the transport pocket 30 is inserted into the carrier hook 18′ in a manner rotated about 180° (angle degrees). Thus the transport pocket 30 in FIG. 4 which is rotated anti-clockwise has a pocket opening 36 which is aligned to the right in the conveying direction F. This transport pocket 30 can now for example be filled from the right. The transport pocket 30 in FIG. 6 which is rotated in the clockwise direction now has a pocket opening 36 which is aligned to the left in the conveying direction F. The transport pocket 30 can now be filled for example from the left.

FIG. 5 represents a detail section of FIG. 4 in which the runner vehicle, the carrier hook 18′ and the suspension hook 19 are shown. The carrier hook 18′ has no pronounced stable rest position or locations 22 and 23 since the recesses 11 are absent at these locations. Hence the two stable rest positions or locations are only temporarily stable, specifically as long as the carrier frame 6 of the transport pocket 30 is rotated by external actions. The external action upon the transport pockets 30, as can be effected e.g. by way of a rotation device, is not shown in FIG. 4 and FIG. 6.

In FIG. 5 the suspension hook 19 is rotated in the carrier hook 18′ in the anti-clockwise direction and on account of this is pushed upwards on the connection segment 20 in the direction of the runner vehicle 12. By way of this, the transport pocket 30 or the upper transverse rod is rotated by approx 90° (angle degrees) to the conveying direction F. The transport pocket 30 remains in this alignment for as long as the external action is applied upon the transport pocket 30. A loading of the transport pocket 30 can now be effected from the right considered in the conveying direction F. After the loading of the transport pocket 30 with a conveyed item 32, the external action upon the transport pocket 30 can be ended, by which means it rotates back into the conveying position and the carrier hook 19 or the eyelet 4 assumes the first stable position between the second and third position.

In FIG. 7, the suspension hook 19 is rotated in the carrier hook 18′ in the clockwise direction and by way of this is pushed upwards on the second connection element 20.2 in the direction of the runner vehicle 12 between the first and third position. By way of this, the transport pocket 30 or the upper transverse rod is rotated by approx. −90° (angle degrees) to the conveying direction F. The transport pocket 30 remains in this alignment for as long as the external action is exerted upon the transport pocket 30. A loading of the transport pocket 30 can now be effected from the left considered in the conveying direction F. After the loading of the transport pocket 30 with a conveyed item 32, the external action upon the transport pocket 30 can be ended, by which means the transport pocket 30 rotates back again into the conveying position in the first stable position.

In FIG. 8 and FIG. 9, a conveying unit 1 is shown in the conveying position in which the suspension hook 19 or its eyelet 4 is arranged in the first recess of the first stable position. The runner vehicle 12 is equipped with an identification carrier 19 in the form of a barcode and is moved in the conveying direction F with the help of a drive device via the driver bolt 16. A drive device is not shown in the FIGS. 1-16 . A carrier hook 18 is fastened onto the runner vehicle 12 via a snap connection 24. The suspension hook 19 is inserted into the carrier hook 18′ in a manner leading the transport element 41, e.g. in the form of a transport pocket 30. The suspension hook 19 is arranged on the upper part or end of the carrier frame 8 of the transport pocket 10 and consists of a wire-like material. The upper part of the suspension hook 19 is bent to the transport pocket 30 or to the upper transverse rod by 90° (angle degrees) and forms an eyelet 4 at the outermost end. The eyelet 4 of the transport pocket 30 lies in the first recess 11.1 of the first rest position or location 21. By way of this, the eyelet 4 is aligned along the conveying direction F. Since the eyelet 4 is rotated to the carrier frame 8 of the transport pocket 30 by 90° (angle degrees), the transport pocket 30 or the carrier pouch 30 or the upper transverse rod is aligned perpendicularly to the conveying direction F.

FIG. 8 shows the arrangement of a conveying unit 1 considered from the right in the conveying direction F and FIG. 9 shows the arrangement of the same conveying unit 1 from the left considered in the conveying direction F. By way of the comparison of both figures, the nature of the suspension hook 19 in the region of the carrier hook 18′ can be very easily recognised. The carrier hook 18′ comprises no recesses in the region of the second and third rest position or location 22, 23.

FIG. 10 shows a conveying unit 1 which consists of a runner vehicle 12′ and a transport pocket 30′. The runner vehicle 12′ runs along a conveying rail 53 of the conveying track 70. The runner vehicle 12′ is represented schematically and is not dealt with in more detail here. The transport pocket 30′ consist of a carrier frame with stable side walls which are preferably manufactured of hollow chamber plates. The transport pocket 30′ comprises a front pocket wall 2 leading in the conveying direction F and a rear pocket wall 3 trailing in the conveying direction F. The transport pocket 30′ forms a main receiving compartment 9 between the front pocket wall 2 and the rear pocket wall 3, said main receiving compartment 9 being delimited to the bottom by the pocket base 5.

A flap 27 is pivotally fastened to the rear pocket wall 3 by way of a pocket joint 39. The flap 27 is manufactured of a stable material and at its free end comprises at least one permanent magnet 60 which is fastened to the flap 27 in the direction of the rear end. An iron plate 61 which can interact with the permanent magnet 60 is fastened to the outer wall on the rear pocket wall 3. A closure device 25 is released with the two elements 60 and 61, said closure device able to be opened and closed arbitrarily often. If the flap 27 is pivoted to the rear pocket wall, the permanent magnet 60 of the flap 27 contacts the iron plate 61 and firmly holds the flap 27 on the rear pocket wall 3. The region between the rear pocket wall 3 and the flap 27 forms the auxiliary receiving compartment 29. This compartment is suitable for receiving a further conveyed item 32, for example in the form of an extensive conveyed item 31. An insert opening 28 forms when the flap 27 is opened slightly from the rear pocket wall 3, into which insert opening an extensive conveyed item can be inserted. A subsequent closing of the flap leads to a clamping holding of the extensive conveyed item 31 in the auxiliary receiving compartment 29.

FIG. 11 shows a conveying unit 1 which consists of a runner vehicle 12′ and a transport pocket 30″. The runner vehicle 12′ runs along a conveying rail 53 of the conveying track 70. The transport pocket 30″ consists of a carrier frame with stable side walls which are preferably manufactured from hollow chamber plates. The transport pocket 30″ comprises a front pocket wall 2 leading in the conveying direction F and a rear pocket wall 3 trailing in the conveying direction F. The transport pocket 30″ forms a main receiving compartment 9 between the front pocket wall 2 and the rear pocket wall 3, said main receiving compartment 9 being delimited to the bottom by the pocket base 5.

A further flap 27′ is pivotably fastened to the front pocket wall 2 by way of a pocket joint 39. The flap 27′ is manufactured from a stable material and at its free end comprises at least one first Velcro part 65 which is fastened to the flap 27′ in the direction of the rear end. At least one second Velcro part 66 is fastened on the outer wall at the front pocket wall 2 and can interact with the first Velcro part 65. A first closure device 25′ which can be opened and closed arbitrarily often is realised by the two elements 65 and 66. If the flap 27′ is pivoted to the front pocket wall 2, the two Velcro parts 65 and 66 contact one another and firmly hold the flap 27 on the front pocket wall 2. The region between the front pocket wall 2 and the flap 27′ in turn forms the auxiliary receiving compartment 29. This compartment is designed to receive a further conveyed item 32, e.g. in the form of an extensive conveyed item 31.

FIG. 12 shows a conveying unit 1 which consists of a runner vehicle 12′ and a transport pocket 30″. The runner vehicle 12′ runs along a conveying rail 53 of the conveying track 53. The transport pocket 30″′ consists of carrier frame with stable side walls which are preferably manufactured from hollow chamber plates. The transport pocket 30″′ has a front pocket wall 2 leading in the conveying direction F and a rear pocket wall 3 trailing in the conveying direction F. The transport pocket 30′″ forms a main receiving compartment 9 between the front pocket wall 2 and the rear pocket wall 3, said main receiving compartment 9 being delimited to the bottom by the pocket base 5.

A further flap 27″ is pivotably fastened to the rear pocket wall 3 by way of a pocket joint 39. The flap 27″ is manufactured of a stable material and at its free end comprises at least one rubber band 67 which elastically connects the flap 27″ and the rear pocket wall 3 to one another. For this, the rubber band 67 can be fastened to a side of the rear pocket wall 3 and be tensioned over the complete width of the rear pocket wall 3, in order to be fastened again at the other side of the rear pocket wall 3. The middle region the rubber band 67 covers the flap 27″ which is held on the rear pocket wall by the rubber band. The region between the rear pocket wall 3 and the flap 27″ in turn forms the auxiliary receiving compartment 29. This compartment is suitable for receiving an extensive conveyed item 31. If the flap 27″ is slightly opened from the rear pocket wall 3, the rubber band 31 tensions and an insert opening 28 forms, into which insert opening an extensive conveyed item 31 can be inserted into the auxiliary receiving compartment 29. A subsequent closing of the flap leads to a clamping holding of the extensive conveying item 31 in the auxiliary receiving compartment 29.

FIG. 13 and FIG. 14 show a conveying unit 1, once from the right and once from the left considered in the conveying direction F. The conveying unit 1 consists of a runner vehicle 12 with an identification carrier 10 in the form of a QR-code which is moved along the conveying rail 53. A carrier hook 18′ which interacts with the suspension hook 19 of the transport pocket 30″ is fastened to the runner vehicle 12. The transport pocket 30″ considered in the conveying direction F is rotated in the clockwise direction by 90° (angle degrees), so that the suspension hook 19 of the transport pocket 30″ is situated in the carrier hook 18′ in the third rest position or location. The transport pocket 30″ rotates due to external actions which are not shown here and is held in this position by way of these external actions until the external actions are lifted and the transport pocket 30′″ slides back again into its conveying position, thus transversely to the conveying direction F. The external action in particular is effected by a rotation device.

The transport pocket 30″ in FIGS. 13 and 14 is provided with an identification carrier 10 in the form of a QR-code and comprises a closure device 25 as has already been explained in FIG. 10. The two permanent magnets 60 on the flap 27 interact with the iron plate 61 of the rear pocket wall 3. An extensive conveyed item 31 is clampingly held in the auxiliary receiving compartment 29. No further conveyed item is brought into the main receiving compartment 9 of the transport pocket 30. Generally, one can ascertain that all receiving compartments of a transport pocket 30 can be filled with conveyed items 32, 31. The front side of the transport pocket 30″ of FIG. 13 is shown in FIG. 14.

FIG. 15 shows a rotation device 86 of a conveying facility or a conveying system 50 in a perspective view for rotating the transport pockets 30 and possibly also for the temporary holding of the transport pockets 30 in the second or third position.

A stop and release device 52 and a rotation device 86 for the conveying units 1 are represented successively along a runner rail or conveying rail 53. The conveying units 1 are stopped at the stop and release device 52 and released one after the other. The conveying unit 1 is moved further in a driven manner after the release. The drive of the conveying units 1 is not shown. The conveying units 1 move to the rotation device 86 in the conveying direction F. The rotation device 86 functions similarly to a rocker. A pivot lever 84 is arranged in a pivotably movable manner at the centre on a fixed pivot bearing 85. The pivot lever 84 can be pivoted transversely to the conveying direction F by way of an actuation means 82 in the form of a pneumatic cylinder 83. Hereby, one end of the pivot lever 84 moves upwards and the other end of the pivot lever 84 moves downwards, or vice versa. Joint connections 87 on which active elements 58 are attached are arranged on the ends of the pivot lever 84. On pivoting the pivot lever 84, the active element 58 is moved upwards and downwards in the same cycle as the ends of the pivot lever 84. The active elements 58 in this case have the shape of rods 59. However, they can also have a different shape. The active elements 58 however can also be moved in a guided manner. If a linear guidance is provided for the active elements 58, not shown here, then it is advantageous if the joint connection 87 is designed as a double joint. An active element 58 can be moved into the conveying corridor 71 by way of the rocker-like behaviour of the rotation device 86, along which corridor the transport pockets 30 of the conveying units 1 move.

If the transport pocket 30 is moved past the rotation device 86, the transport pocket 30 contacts one of the active elements 58, which leads to a rotation of the transport pocket 30 about its vertical 33. Depending on which of the two active elements 58 is brought into the conveying corridor 71 of the transport pockets 30, the transport pocket 30 rotates about its vertical 33 in the clockwise direction or the anticlockwise direction. The control device 80 controls the stop and release device 52 and the rotation device 86 in a manner such that the conveying units 1 are released at the correct time and the transport pocket 30 of the conveying units 1 is rotated to the correct side, in order to be able to carry out the necessary operation, such as transfer of conveyed items, at the transport pocket 30.

FIG. 16 shows a rotation device 86 of a conveying facility or of conveying system 50 in a plan view from above. A stop and release device 52, a rotation device 86 and a loading station 88 for conveying units 1 are successively represented along a runner rail or conveying rail 53. The conveying units 1 are stopped and successively released at a stop and release device 52. After the release, the conveying unit 1 is moved further in a driven manner and led to the rotation device 86. The rotation device 86 is set by way of the actuation means 82 such that the transport pocket 30 of the conveying unit 1 is rotated in a manner such that the transport pocket 30 is correctly aligned for the loading. The transport pocket can be filled from the front pocket wall 2 or however from the other side, thus from the rear pocket wall 3 of the transport pocket 30.

Generally, other receiving compartments or all receiving compartments can also be filled with conveyed items 32.

The conveying unit 1 now with the rotated transport pocket 30 is conveyed further along the conveying track 70 up to the loading device or loading station 88. In the loading device or loading station 88, the transport pocket 30 which is held in a rotated manner is opened with the help of an opening device 54. A conveyed item 32 is transferred into the opened transport pocket 30 with the help of a feed device 55. The feed device 55 comprises a conveying belt 56 which can be moved by way of a drive unit 57 and herewith conveys the conveyed item 32 into the open transport pocket 30. The opening device 54 and the drive unit 57 of the feed device 55 are controlled by the control device 80 such that the sequences are carried out harmonically and in a manner matched to one another.

According to a particular embodiment of a conveying system, the runner vehicle 53 and with this the carrier hook 18 in a loading or unloading position according to FIG. 17 is inclined in a plane which lies perpendicularly to the conveying direction F. Here, this is effected by way of the inclining of the conveying rail 53 in the mentioned plane.

The inclining of the conveying rail 53 is achieved e.g. by way of torsioning or twisting the conveying rail 53 about its longitudinal axis.

The shown carrier hook 18 according to FIG. 17 merely has a second and third rest position or location 11.2, 11.3. However, with this embodiment a carrier hook with a first, second and third rest position or location 11.1, 11.2, 11.3 can also be applied, as is shown e.g. in FIGS. 2 and 3. The embodiment according to FIG. 17 is hereinafter described by way of a carrier hook 18 according to the FIGS. 2 and 3.

Whereas in the conveying position, a runner vehicle plane which is arranged perpendicularly to the rotation axes of the carrier rollers 13 is inclined vertically, as is shown in FIG. 8 and FIG. 9, this runner vehicle plane in the inclined or tilted position of the runner vehicle 12 forms an acute angle to the vertical.

On account of the inclining or tilting of the carrier hook 18, the first rest position or location 11.1, here designed as a recess, depending on the inclination direction is lifted to a higher level of potential energy compared to the second or third rest position or location, here likewise designed as recesses. The second or third rest position or location can even have the lowest potential energy level-depending on the inclination direction.

By way of this, on account of gravity and in particular in an automatic manner, the suspension hook 19 or its eyelet 4—depending on the inclination direction—slips into the second or third rest position or location 11.2, 11.3 of the carrier hook 18 which is to say into the associated recess into the loading or unloading position.

By way of lifting the inclination of the runner vehicle 12 and accordingly also of the carrier hook 18, this again assumes the conveying position. Accordingly, the first rest position or location 11.1 forms the lowest level of potential energy compared to the second and third rest position or location 11.2, 11.3, so that the suspension hook 19 or its eyelet 4 on account of gravity and in particular in an automatic manner again slips or slides into the first rest position or location into its conveying position.

If the suspension hooks 19 of the conveying units automatically slip or slide to and fro between the first and the second 11.1, 11.2 or the first and third rest position or location 11.2, 11.3 in dependence on the inclination, then one can make do without a rotation device according to FIGS. 15 and 16.

However, a rotation device can also be necessary for displacing the suspension hook 19 between the first, second and third rest position or location. The inclination of the carrier hook 18 however simplifies the moving of the suspension hook from the first into the second or third rest position or location 11.2. 11.3, since the latter in the respective inclination position has a lower level of potential energy compared to the inclination-free conveying position.

On assuming the second or third rest position or location 11.2, 11.3 by the suspension hook 19, the transport element 41—here a transport mount—as already mentioned in detail further above is rotated about a vertical axis to the side into a loading or unloading position. In the present embodiment example the rotation is 90°.

On assuming the first rest position or location 11.1 by the suspension hook 19, the transport element 41 is again pivoted about the vertical axis back into the conveying position in which this in particular is aligned with a leading transport element wall frontally to the conveying direction F.

The present invention is not limited in its scope to the specific embodiments which are described here. In contrast, different further modifications of the present invention result for the man skilled in the art from the description and the associated figures, additionally to the examples which are disclosed here, such further modifications likewise falling within the protective scope of the claims. Additionally, different references are cited in the description, the contents of whose disclosure is herewith incorporated in its entirely into the description by reference.

1. A conveying unit for the suspended transport of transport elements which receive conveyed items, in a conveying system, in particular in a rail-led conveying system or in a conveying chain system, with the conveying unit comprising:
a carrier hook which is attached to a conveying element, in particular to a runner vehicle or to a conveying chain link,
a transport element, and
a suspension hook which is attached to the transport element, wherein the suspension hook is mounted in the carrier hook in a suspended manner,
wherein the carrier hook is designed such that the suspension hook can assume at least three stable positions in the carrier hook, wherein the suspension hook in a first stable position is rotated about an angle with respect to the suspension hook in a second stable position, and wherein the suspension hook in the first stable position is rotated with respect to the suspension hook in a third stable position about an angle which is different than that in the second stable position.

2. The conveying unit according to claim 1, wherein the suspension hook can be brought to and fro between the first stable position and the second stable position and the third stable position such that the suspension hook lies constantly on the carrier hook.

3. The conveying unit according to claim 1, wherein the carrier hook has a first rest position or location, a second rest position or location and a third rest position or location, and the suspension hook in the first stable position lies on the first rest position or location, in the second stable position lies on the second rest position or location and in the third stable position lies on the third rest position or location, and a connection segment is arranged each between the first rest position or location and the second rest position or location and the third rest position or location, on which connection segment the suspension hook can be brought to and fro between the first stable position, the second stable position and the third stable position in a sliding manner.

4. The conveying unit according to claim 3, wherein the carrier hook is designed such that in a certain first spatial orientation or arrangement of the first rest position or location of the carrier hook, the suspension hook on the first rest position or location can assume the first stable position in which the suspension hook is aligned in a first plane, and in a second spatial orientation or arrangement of the second rest position or location of the carrier hook which is different from the certain first spatial orientation or arrangement, the suspension hook on the section rest position or location can assume the second stable position in which the suspension hook is aligned in a second plane, and in a third spatial orientation or arrangement of the third rest position or location of the carrier hook which is different from the certain second spatial orientation or arrangement, the suspension hook on the third rest position or location can assume the third stable position in which the suspension hook is aligned in a third or likewise in the second plane.

5. The conveying unit according to claim 4, wherein in a certain first spatial orientation or arrangement of the first rest position or location of the carrier hook, the first position corresponds to a minimum of the potential energy of the transport element which is mounted in a suspended manner, and by way of rotating the suspension hook about a certain rotation angle the suspension hook can be brought to and fro between the first position and the second position or the third position on the carrier hook.

6. The conveying unit according to claim 1, wherein by way of rotating the suspension hook or by way of rotating the transport element about a vertical of the conveying direction, the suspension hook can be brought to and fro between the first stable position and the second stable position and the third stable position.

7. The conveying unit according to claim 1, wherein the transport element is a container, in particular with at least one flexible wall, in particular a flexible fabric wall.

8. The conveying unit according to claim 1, wherein the transport element is a transport pocket and the transport pocket in particular comprises a rear pocket wall and a front pocket wall, said walls being flexibly connected to one another via a pocket base such that they are movable to and fro between a first state in which they form a receiving compartment which is open to the top and can be filled from above, and a second state in which they lie tightly next to one another and form a folded-together transport pocket, wherein the rear pocket wall is extended upwards beyond the height of the front wall with the suspension hook for fastening the transport pocket to the conveying unit, and wherein the suspension hook is attached to an upper end of a carrier frame.

9. A rotation device, designed for rotating the transport elements of conveying units according to claim 1, in a conveying system, in particular in a conveying system which is led by conveying rails or in a conveying chain system, for the suspended conveying of conveyed items along a conveying corridor, wherein the transport elements are rotatable about their vertical axis, wherein the rotation device comprises at least one activatable active element which can be brought into the conveying corridor of the transport elements and can consequently act upon the transport elements such that the transport elements rotate to the right or to the left about their vertical axis on conveying.

10. The rotation device according to claim 9, wherein the at least one activatable active element is arranged outside the conveying corridor.

11. The rotation device according to claim 9, comprising two active elements that are activatable at alternate sides by a drive element.

12. The rotation device according to claim 11, wherein the two active elements can be brought into the conveying corridor of the transport elements at alternate sides in the region of the transport elements, in particular in the region of the carrier frame of the transport elements.

13. A method for loading conveying units according to claim 1 with conveyed items at a loading device or station, wherein the loading with the conveyed items is effected transversely to the conveying corridor of the transport elements, and wherein the transport elements before the loading at the loading device or station are rotated about their vertical axis into the alignment which is envisaged for loading by way of a rotation device.

14. A method for unloading conveyed from conveying units according to claim 1, at an unloading device or station, wherein the unloading of the conveyed items is effected transversely to or in the conveying direction of the conveying element, and wherein the transport elements before the unloading at the unloading device or station are rotated about their vertical axis into alignment which is envisaged for unloading by way of a rotation device.

15. A conveying system for the guided, suspended transport of transport elements, in particular transport pockets, along a conveying path or track, in particular a rail-led conveying system or a conveying chain system, with at least one unit according to claim 1.

16. The conveying system according to claim 15, wherein the conveying system is designed such that the carrier hook in a loading or unloading position, with respect to a conveying position, is inclined in a plane which is arranged perpendicularly to the conveying direction, such that the suspension hook on the second rest position or location can assume the second stable position or on the third rest position or location can assume the third stable position, depending on the inclination direction.

17. A transport pocket for conveying units according to claim 1, in particular for a conveying system such as a rail-led conveying system or a conveying chain system, for the suspended conveying of conveyed items along a conveying track such as conveying rail, wherein the upper part of a carrier frame of the transport pocket forms a suspension hook with an upper section, such as an eyelet,
wherein the upper section such as eyelet of the suspension hook is rotated or aligned at an angle, in particular at right angles with respect to a lower section of the suspension hook or with respect to the carrier frame or a rear wall of the transport pocket.
